(19) United States
(12) Patent Application Publication
(10) Pub. No.: US 2009/0193751 A1
(43) Pub. Date: Aug. 6, 2009

(54) Process for regulating the size of residential construction

(76) Inventor: Seymour Auerbach, Chevy Chase, MD (US)

Correspondence Address: Seymour Auerbach, 115 Hesketh Street, Chevy Chase, MD, 20815, US

(21) Appl. No.: 12/318,972

(22) Filed: Jan. 14, 2009

Related U.S. Application Data
(60) Provisional application No. 61/006,452, filed on Jan. 15, 2008.

(51) Int. Cl. E04B 1/00; G06Q 10/00

(52) U.S. Cl. 52/741.1; 705/500

(57) ABSTRACT

To regulate the size of proposed residential construction in a community: establish a BULK FACTOR including a ratio of the volume of one of new construction; an extant residence and an addition thereto; an extant residence and an accessory building or buildings; or an extant residence, an addition thereto, and an accessory building or buildings, to the area of a specific lot. Thereafter, limit the size of the one proposed construction to a bulk factor no greater that the established BULK FACTOR.

### REFERENCE TO PRIOR APPLICATION

The present invention is based on and claims priority to my prior provisional application Ser. No. 61/006,452 filed Jan. 15, 2008, the subject matter of which is incorporated herein by reference.

### FIELD OF THE INVENTION

This invention relates to a process for regulating the size of proposed residential construction on a specified lot and particularly relates to regulating the size of a proposed residence, an extant residence and an addition thereto, and/or a detached accessory building, (such as a garage, tool shed, pool house or other detached structures), so as to conform the total bulk of the construction in keeping with the neighborhood, community or district (hereinafter “community” or “communities”) in which it is to be constructed, e.g. in keeping with the architectural scale of the residences extant in the community. More particularly, the present invention relates to a process for defining limitations to the size of a proposed residential construction project, e.g. a new residence, an extant residence with a proposed addition and/or a detached accessory building such that it does not exceed a certain BULK FACTOR, which is defined by a community's authorized controlling regulatory body, in keeping with the architectural scale of the pre-existing residences of the community.

### BACKGROUND AND HISTORY

Traditionally, and perhaps legally, legislation or other means of controlling the aesthetics of a structure have been ruled as being contrary to the exercise of personal persuasions of “taste”. Further, the economy affecting the older established communities at the time they were built historically manifested residences that are smaller than could have been constructed if built out to the maximum permitted by the community's Zoning Code._As population has burgeoned and prosperity has followed, and housing on increasingly larger properties (hereinafter “lot” or “lots”) has spread increasingly further from the central cities, a practice has followed whereby small lots in older, closer in, communities are purchased and the small pre-existing residences thereon are either torn down and replaced with comparatively huge residences, or additions and/or accessory structures are added to the pre-existing residences. Both cases push the envelope of existing set-back, front, side and rear yard requirements and height restrictions established in the Zoning Regulations of the communities to their limits and often produce residences that offend the pre-existing scale of the community.

Most extant community Zoning Codes attempt to control the size of residences built upon lots in the community by a) limiting the height of a structure, b) limiting the percentage of the lot which the residence, including any accessory structures, may cover (sometimes referred to as the “Ground Area of the Building), and/or c) establishing front, rear and side yard setbacks on the lot in which no structure, other than accessory structures (with their own setback requirements), is permitted. It should be understood that some Zoning Codes permit the intrusion of outside stairways such as at entry stoops with or without protective roofs, chimneys, cornices, eaves, window sills, bay windows, verandas, porches, balconies and similar projections into required front, rear and side yards. Another often proposed or enacted zoning control is to limit the floor area of the structure as a ratio of its lot area. While this is usually preserved for other than single family residential development, it is sometimes found in Zoning Codes pertaining to residential buildings. However, it does not and cannot, without extensive prohibitive zoning code additions, cover all possible architectural embellishments that are extraneous to a simple ratio of floor area to lot area. It will also be appreciated that all communities do not have identical Zoning Codes and may differ in these details or the way they express them.

Now, with the economy permitting, and the desire for more spacious and more luxurious residences, the builders of these residences are often building to the maximum of the extant Zoning Code restraints, thereby intruding into the established scale of the community. These large residences have come to be known by the disparaging appellation of “McMansions”. Certain embellishments such as multi-story entry halls; numerous decorative dormers or single, huge dormers; bay windows; expansive raised entry stoops and verandas, with their attendant swell of steps and balustrades; and ever increasing story heights have added to the undesirable intrusive bulk of these newer comparatively very large residences into the established scale of the existing communities.

Though the existing Zoning Code controls, taken separately as was their intent, served their purposes under the economy and living styles of the time they were written, now, when taken together and pushed to their combined maximum, they have come to be utilized to produce offending intrusions into the preferred scale of existing communities.

### SUMMARY OF THE INVENTION

This invention provides an added limitation to an existing or proposed new Zoning Code which directly controls the maximum bulk of all structures combined that may be built on a lot of a given size by establishing a BULK FACTOR. Most, if not all the existing zoning controls noted above other than Floor Area Ratio, each having a separate desirable purpose in its own right, may remain in place, permitting varying architectural configurations under a BULK FACTOR zoning control and thereby allowing for varying aesthetic expression while enabling the new or added-to residences to be in keeping with the scale of the community. The BULK FACTOR will apply to all aspects of the residence's construction including, but not limited to, dormers, chimney masses, overly sized cornices and window sills, bay windows above-grade terraces, verandas and stoops, accessory buildings, open porches, sheds and garages. It includes all structures above existing grade including any portion of a basement or cellar: such grade being that which existed prior to the last conveyance of ownership of a lot. The BULK FACTOR includes all the above grade volumetric aspects of the residence and its accessory structures whether or not they enclose a functional space.

It is to be also further understood that overhanging eaves and similar projections of limited thickness, canopies of limited dimensions over entry steps, unenclosed porches of limited sizes and/or with or without roofs of limited thickness, may or may not be included in the determination of the total bulk as the public body establishes the laws and regulations pertaining to the BULK FACTOR which determines what is to be calculated in determining the BULK FACTOR.

Accordingly, in a preferred embodiment of the present invention, there is provided a process for regulating the size of proposed residential construction on a specified lot in a community, comprising the steps of
a) establishing a BULK FACTOR including a ratio of the volume, measured above its directly adjacent grade, of one of the following proposed residential constructions:
   1) a new construction;
   2) an extant residence and an addition thereto;
   3) an extant residence and an accessory building or buildings; or
   4) an extant residence, an addition thereto, and an accessory building or buildings;
to the area of the specific lot; and
b) limiting the size of the one proposed construction to a bulk factor no greater than the established BULK FACTOR.

### BRIEF DESCRIPTION OF THE DRAWING FIGURES

FIG. 1 is a schematic isometric view of an exemplary residential building with a free standing garage in the rear yard, on a residential Lot typical of those in a certain community, which meets all of the front, side and rear yard set-backs, percentage of lot coverage and height limitation of the community:

FIG. 2 is a schematic isometric view illustrating a residence which can be built on the same Lot as shown in FIG. 1 when its design is built out to the maximum allowed by the existing Zoning Code inclusive of all its architectural volumetric aspects:

FIG. 3 is a schematic isometric view of a proposed residence on the same Lot as shown in FIGS. 1 and 2, but built to the limits of a proposed BULK FACTOR: and

FIG. 4 is a schematic isometric view of a proposed residence on a Lot of the same horizontal size as shown in FIG. 3 and which has sloping topography, but the same BULK FACTOR as in FIG. 3, and which demonstrates an entirely different architectural configuration conforming to all the other existing Zoning Code restrictions and which reveals the opportunity for individual architectural expression while still maintaining the desired scale of the community.

It is to be understood that all drawing figures shown assume the same Lot area, and are meant to demonstrate the comparison of varying bulk factors. It is to be understood that most communities are composed of lots of varying areas and that the BULK FACTORS therefore will allow residences of various sizes and architectural expression. The regulating body of a community may vary the BULK FACTOR in a manner as described.

### DETAILED DESCRIPTION OF THE INVENTION

For the purposes of clarity, the accompanying drawing figures have adopted the following illustrative and representative dimensions: Lot area=6,660 square feet (74 ft wide×90 ft deep). The drawing figures assume the following other zoning controls: Maximum Permissible Lot Coverage=35%; Front Yard Setback=25 feet; Side Yard Setbacks=9 feet; Rear Yard Setback=20 feet. Accessory structures are permitted to be located within 5 feet of Rear or Side Property Lines. The bulk (volume) of the structures is stated in cubic feet.

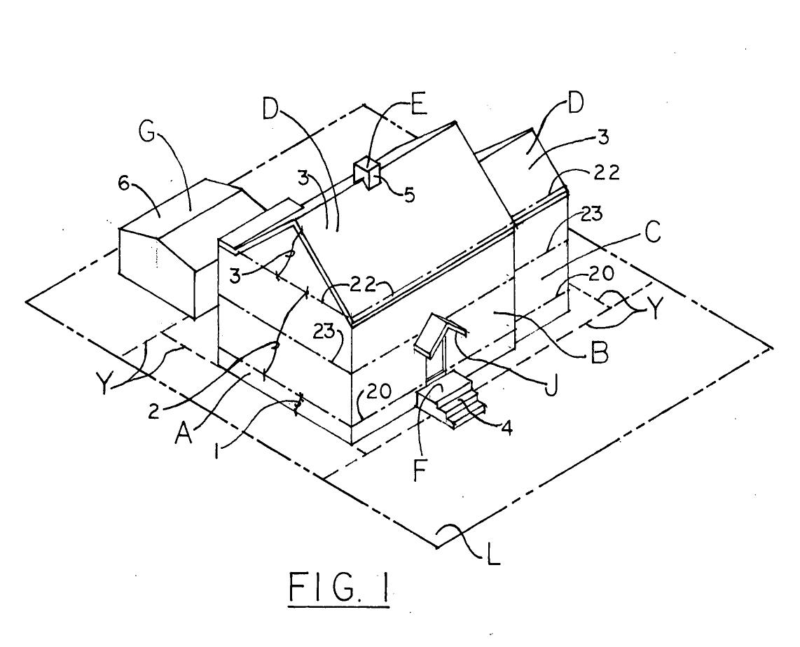

FIG. 1 illustrates an assumed existing residence typical of the residential scale in an assumed existing community on a Lot L, and with yard-setbacks Y and Zoning Constraints described above. The total bulk of the structures on Lot L includes: the volume 1 of the basement or cellar story A above the directly adjacent grade; the volume 2 of the basic building B inclusive of the side extension C from the first floor 20 to the attic floor 22 including the second floor 23; the volume 3 of the attics D above the attic floor 22 of the basic building B and the side extension C; the volume 4 of the front stoop F; the volume 5 of the chimney E not enclosed within the basic building B; and the volume 6 of the garage G. The total bulk is therefore the combined above grade volumes of the building construction on Lot L and includes, for example, a main residence, any and all accessory buildings attached or not attached to the main residence, such as garages, carports, garden sheds, pool houses and any similar structure having a volume above its directly adjacent grade and which building construction conforms to the community's existing zoning code or regulations. The bulk factor is the total bulk divided by the area of the Lot. In the case of this FIG. 1, the volume of the roof J over the small entry stoop is not included in the BULK FACTOR.

In the illustrated example of FIG. 1 the bulk factor is ascertained as follows: the area of Lot L is 6,600 square feet; the bulk of the basement or cellar story A above the directly adjacent grade is its area of 1,214 square feet times its dimension of 2 feet above the directly adjacent grade, or 3,026 cubic feet; the bulk of the basic building B including side extension C is its area of 1.214 square feet times the height from the first floor 20 to the attic floor 22 of 19.5 linear feet, or 23,673 cubic feet; the bulk of the attics D above the basic building B inclusive of its side extension C is 1,214 square feet times an average height of 6 feet, or 7,284 cubic feet; the bulk of the front stoop F (its roof J, in this diagram being exempted from the building bulk) is its average area of 16 square feet times its height of 1.5 feet, or 24 cubic feet; the bulk of the exposed portion of the chimney E is its area of 6 square feet times its average height above the roof of 3.5 feet, or 21.0 cubic feet; and the bulk of the garage G is its area of 324 square feet times its average height of 9.0 feet, or 2,916 cubic feet. The total bulk therefore is 37,244 cubic feet. The total bulk divided by the lot area of 6,660 square feet yields a bulk factor of 5.59.

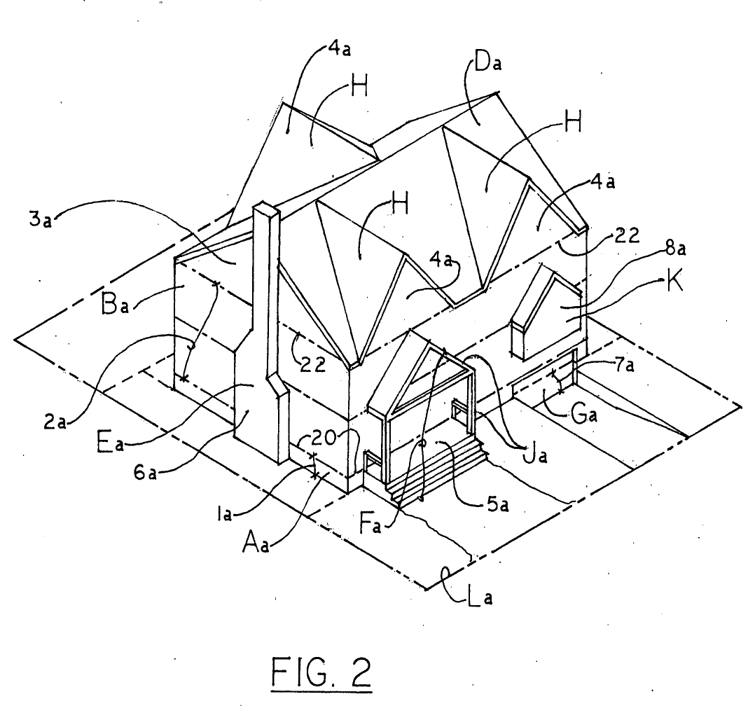

FIG. 2 is an illustration of an arbitrary architectural configuration of a residence built to the maximum size permitted under the existing Zoning Regulations on the same size Lot L as in FIG. 1. It includes the volume 1a of a basement or cellar Aa above the directly adjacent grade to the first floor 20; the volume 2a of a basic building Ba; the volume 3a of a large attic Da above basic building Ba floors 20 to 22; the volume 4a of the three smaller attics H; the volume 5a of the large entry stoop Fa, including the space defined by its columns and supported roofs Ja; the volume 6a of the portion of a chimney Ea not enclosed within the basic building Ba, the basement or cellar Aa or the attic Da; a volume 7a of that portion of a garage Ga exposed below pre-existing directly adjacent grade; and a volume 8a of a bay K permissibly built to overhang into the Front Yard. The total bulk of this structure is 77,070 cubic feet, which yields a bulk factor of 11.57, i.e. the total bulk of 77,070 cubic feet divided by the Lot area of 6,660 square feet. This demonstrates an increase of 107% more bulk than the bulk factor of the existing residence illustrated in FIG. 1 and also demonstrates the extreme latitude of the size of construction of new, huge residences possible on existing lots under existing zoning regulations which do not include restrictions imposed as bulk factor controls.

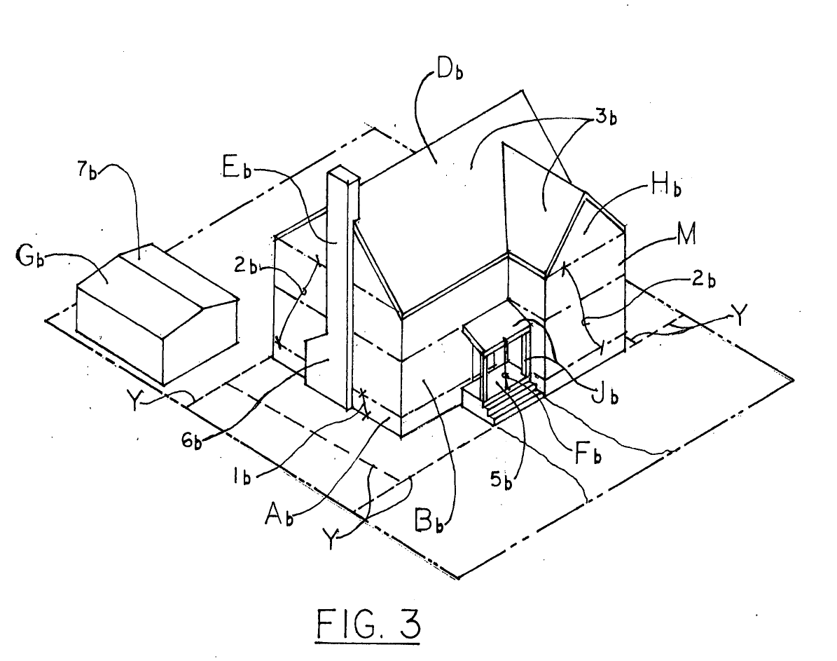

FIG. 3 is an illustration of an arbitrary architectural configuration of a residence built to the volume established by an arbitrarily determined BULK FACTOR of 7.0 and in keeping with yard set-backs Y, percentage of Lot coverage and height restrictions of the existing Zoning Regulations which permitted the “Mc Mansion” demonstrated above in FIG. 2. It includes the Volume 1b of the basement or cellar story Ab above the directly adjacent grade; the volume 2b of the basic building Bb including a front extension M; the volume 3b of the attics Db and Hb; the volume 5b of the front stoop Fb, including the space defined by its columns and its supported roof Jb; the volume 6b of the chimney Eb not enclosed within the basement or cellar story Ab, the basic building Bb or the attic Db; and the volume 7b of the garage Gb. The total bulk of this structure and its accessory building, built to the established BULK FACTOR of 7.0, is 46,620 cubic feet (7.0 times the Lot area of 6,660 square feet). This is an increase of 28% more than the bulk factor of the existing residence shown in FIG. 1. It represents a BULK FACTOR established by the regulating authority to be an acceptable maximum BULK FACTOR permissible to maintain the desired scale of the community while recognizing increases in land value and patterns of living.

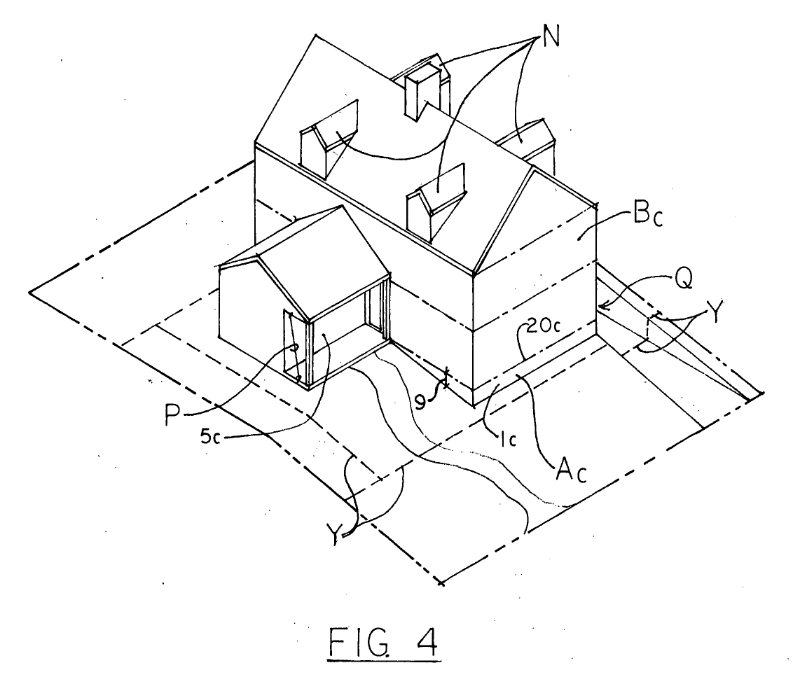

FIG. 4 is an illustration of an arbitrary architectural configuration of a residence built to exactly the same established BULK FACTOR of 7.0 as in FIG. 3, on a Lot of identical horizontal area but with different topography. It contains exactly the same bulk (cubic volume) as demonstrated in FIG. 3 including the volume 5c of the entry porch P. All dormers N are included in the determination of the building's bulk. Where the grade 9 at the face of the building varies, only that volume 1c of the basement or cellar Ac above the directly adjacent sloping grade up to the first floor 20c is included in the building's calculated bulk and attributable to its bulk factor. The volume created by the portion of the face of the building exposed to the depressed (excavated) driveway Q is included in the calculated bulk factor.

It is to be understood that where the dimension from the first floor to existing directly adjacent grade varies, the bulk (volume) of the portion of these differing dimensions are to be calculated to the centerline of the structure.

It is to be further understood that in FIGS. 2, 3 and 4, the volume of the structure has been influenced by such things as increased story heights, double story entry hallways, and dormers; often desired features of new residences. But it will be appreciated that such features, which may or may not provide extra usable floor space do increase the volume of the building and contribute to its bulk. The inclusion in the bulk factor of a building of decorative dormers, high interior spaces, large entry verandas with or without roofs, and similar architectural embellishments on or within the residence is an essential control to maintaining the desired scale of the community. It will be further appreciated that the more comprehensive bulk factor control is, in contrast to Floor Area Ratio control, an easier and more effective parameter to conform a community to the scale it desires.

The BULK FACTOR, of course, is established by the public body having the power of establishing laws or regulations pertaining to the construction of buildings under its authority for its community. It is assumed that the authoritative body will exercise its authority to establish a BULK FACTOR consistent with the scale of its community by whatever process or study it deems appropriate to its determination.

Further, the process set forth here establishes a zoning control process, which, along with those zoning constraints already in place, provides a regulation by which a community may control the bulk of new buildings so as to preserve the community's scale. The addition of bulk control does not inhibit changes to existing zoning constraints as may also be deemed necessary by the community's regulating body. This process also provides a control of the bulk and scale of new additions added to existing buildings, the combined bulk being subject to a maximum established BULK FACTOR without imposing constraints on personal architectural expression. Accessory structures such as free-standing garages and sheds are also included in the calculation of the bulk factor.

The bulk factors used above with respect to FIGS. 3 and 4 are representative only and are not absolute. The community regulating authority may determine and therefore establish a desired BULK FACTOR in keeping with various aspects and scale of the community as noted above. The BULK FACTOR may be established by one of many methods including one of the following: a) calculating the existing bulk factor of select residences in the community and averaging them; b) calculating the bulk factor of a preferred residence; or c) calculating the bulk factor of all the residences in the community and averaging them. The BULK FACTOR may also be arbitrarily established for one or more of many reasons, such as the increase in value of land, recognition that the community can tolerate or benefit from an increase of the bulk factor by some magnitude, or for other good purpose and/or reason.

Thereafter an application for a permit for the construction of any new building or any addition to an existing residence, inclusive of existing or proposed accessory structures, proposed to be constructed in the community shall be submitted to the community's regulating authority and contain complete calculations of the bulk factor of the proposed construction, the area of the lot upon which the structure(s) is to built, and a plot plan indicating the positioning of the structure(s) on the lot and indicating its compliance with any and all setbacks and other requirements of all other zoning regulations. The calculated bulk factor of the proposed construction may thus be preferred and easily confirmed as being no greater than the established BULK FACTOR. The form of the presentation of the application is to be determined by the regulating authority to afford easy conformation of the proposed construction with all aspects of the community's zoning regulations inclusive of the BULK FACTOR.

It is also to be understood that the regulating body of the community can, if it so determines to be in the interest of the community, vary the established BULK FACTOR as it applies to lots of dissimilar areas rather than applying only a single BULK FACTOR to all lots irrespective of their areas. This permits the regulating body of the community to, among other considerations, a) favor development in areas of the community which are deemed in need of more development, b) provide relief for construction on lots having particular topographical constraints needful of such relief, or c) other similar considerations other than favoritism to particular lot owners.

What is claimed is:

1. A process for regulating the size of proposed residential construction on a specified lot in a community, comprising the steps of:
a) establishing a BULK FACTOR including a ratio of the volume, measured above its directly adjacent grade, of one of the following proposed residential constructions:
1) a new construction;
2) an extant residence and an addition thereto;
3) an extant residence and an accessory building or buildings; or
4) an extant residence, an addition thereto, and an accessory building or buildings;
to the area of a specific lot; and
b) limiting the size of said one proposed construction to a bulk factor no greater than the established BULK FACTOR

2. A process according to claim 1 wherein the step of establishing the BULK FACTOR includes determining existing bulk factors of a predetermined number of buildings on their extant lots in a selected community, and averaging the existing bulk factors to determine the established BULK FACTOR.

3. A process according to claim 1 wherein the steps of establishing the BULK FACTOR includes determining existing bulk factors of a predetermined number of buildings on their extant lots in a selected community, averaging the existing bulk factors to determine an average bulk factor, and including increasing the average of the determined bulk factors by a selected number to determine the established BULK FACTOR.

4. A process according to claim 2 determining the bulk factors of all residences on all lots in the selected community and averaging them to determine the established BULK FACTOR.

5. A process according to claim 1 wherein the step of establishing the BULK FACTOR includes determining the bulk factor of a predetermined residence on its specified lot.

6. A process according to claim 1 including varying the established BULK FACTOR for lots having different areas.

7. A process according to claim 1 regulating the size of a proposed building on a specific lot by increasing or decreasing the BULK FACTOR deemed appropriate for the community.
